(19) United States
(12) Patent Application Publication
(10) Pub. No.: US 2008/0005699 A1
(43) Pub. Date: Jan. 3, 2008

(54) METHOD AND SYSTEM FOR PODCAST SEARCH AND SELECTION

(75) Inventors: JOSEPH L. DVORAK, BOCA RATON, FL (US); MARK A. BARROS, WELLINGTON, FL (US); STUART S. KREITZER, CORAL SPRINGS, FL (US); VON A. MOCK, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/428,265

(22) Filed: Jun. 30, 2006

(51) Int. Cl. G06F 3/048

(52) U.S. Cl. 715/836

(57) ABSTRACT

An electronic device (160) and method (400) is provided for podcast searching and selecting. The electronic device can provide a display (210) for visualizing podcast attributes and presenting one or more visual icons (350) in a three-dimensional grid (320), wherein a visual icon identifies one or more attributes of a podcast. The electronic device can include a podcast browser (220) for searching and selecting one or more visual icons presented in the display, where the podcast browser provides multi-level viewing for the one or more visual icons.

### FIELD OF THE INVENTION

The present invention relates to multimedia systems and, more particularly, to podcasts.

### BACKGROUND

The use of portable electronic devices and mobile communication devices has increased dramatically in recent years. Mobile communication devices such as cell phones and portable media players establish multimedia communication with other communication devices over landline networks, cellular networks, and, recently, wide local area networks (WLANs). Such devices are capable of distributing various forms of media to a general audience. This can include a podcast, which is a method of distributing multimedia files, such as audio programs or music videos, over the Internet for playback on mobile devices and personal computers. Podcasters can broadcast media files from a website that can be automatically downloaded or streamed to podcast clients. The podcast clients can subscribe to a podcast on their computer or mobile device, which may be an episode of a show, a newscast event, or a blog.

As the popularity of podcasts rise, there are many various categories of podcasts from which to choose. Podcasts can be arranged by category and presented in a list format or in a bulletin board format. For example, mobile device users can select from a text list of podcast names, or by clicking an image link to receive a podcast. However, the listings do not provide sufficient information for a user to rapidly search and select podcasts. A need therefore exits for browsing one or more podcasts available to a communication device.

### SUMMARY

One embodiment of the invention is directed to a media device for visualizing podcast attributes. The media device can include a display for presenting one or more visual icons in a three-dimensional grid, and a podcast browser for searching and selecting the visual icons in the display. A visual icon can identify one or more attributes of a podcast. Attributes can include a number of podcast listeners or a popularity rating. The attributes can correspond to aspects of the visual icon which can include a height, a width, a color, a color shade, or a label of the visual icon. The podcast browser can provide multi-level viewing for the one or more visual icons, thereby allowing a user to search and select podcasts in the podcast browser.

Another embodiment of the invention is directed to a mobile device for presenting one or more podcasts based on a geographic location of the podcast, wherein the geographic location corresponds to a location of where the podcast was created. The media device can present a geographical map of a region, determine a location of a podcast in the region, and present a visual icon of the podcast at a position in the geographical map corresponding to a location of the podcast. The location of the podcast can correspond to a location where the podcast was created or a location of the server hosting the podcast. The visual icon can identify one or more attributes of the podcast.

Embodiments of the invention also concern a method for podcast searching and selecting. The method can include determining one or more attributes of a podcast, creating a visual icon from the one or more attributes, and presenting the visual icon in a three-dimensional podcast browser. The one or more visual icons can be presented in the podcast browser for identifying one or more podcasts, wherein an attribute of a podcast is specified as a height, a width, a color, a shade, or a label of the visual icon.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a diagram of a mobile communication environment;

FIG. 2 is a schematic of a media device in accordance with the embodiments of the invention;

FIG. 3 is a diagram of a podcast browser in accordance with the embodiments of the invention;

FIG. 4 is a category view and a podcast view in accordance with the embodiments of the invention;

FIG. 5 is an attribute table in accordance with the embodiments of the invention;

FIG. 6 is a visual icon in accordance with the embodiments of the invention;

FIG. 7 is a method for podcast browsing in accordance with the embodiments of the invention;

FIG. 8 is a method for podcast browsing based on geographic location in accordance with the embodiments of the invention; and

FIG. 9 is a geographical map with overlaid visual icons in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processor” can be defined as any number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The term “podcast” is defined as a method or system for distributing multimedia files, such as audio programs or music videos, over the Internet for playback on mobile devices and personal computers. The term “visual icons” is defined as an object that can be placed on a screen and visualized. The term “podcast attribute” can be defined as an attribute of a podcast, for example, a number of subscribers to a podcast, a length of a podcast, a popluarity of a podcast, a location of the podcast, a location of where the podcast was created. The term “region” can be defined as a geograpical area which can be described by county code, area code, zone, city, sub-urb, district, or a description of a geographical area, for example, such as mountains, central, north, south, east, west. A “podcast browser” is defined as a system providing resources for searching and selecting one or more podcasts based on one or more attributes of a podcast that are presented as visual icons.

Embodiments of the invention concern a method and system for searching and selecting podcasts based on a visualization of podcast attributes. The method and system can allow a user to quickly browse and identify a podcast based on one or more podcast attributes. One or more attributes of the podcast are collectively presented as a visual icon. The visual icon can be presented in a three-dimensional display wherein aspects of the visual icon correspond to one or more attributes of a podcast. For example, a height of the visual icon can identify how many people are listening to the podcast. A width of the visual icon can identify how many podcasts are in a podcast category. The color of the visual icon can reveal the subject matter of the podcast. The aspects of the visual icon can be adjusted based on a user's listening behavior or a podcast community's listening behavior. For example, the height of the visual icon can be updated hourly to reveal the popularity of a podcast. Podcasts to which the user subscribes can also be associated with an aspect of the visual icon. Embodiments of the invention allow a user to rapidly identify podcasts based on the visual icons. The visualization facilitates the interfacing by which users can identify podcasts prior to downloading a podcast.

Embodiments of the invention also provide a mobile device to facilitate a searching and selecting of one or more podcasts in a geographical region. A visual icon can be presented on a map at a position corresponding to the geographical location of the podcast. The visual icon can identify one or more attributes of the podcast in that region. For example, a height, a width, a color, a color shade, or a label of a visual icon can correspond to one or more attributes of the podcast in that particular region. In one aspect, a user can select a region to find one or more podcasts in the region and evaluate a popularity of the podcast in the region. The media device can also include a zoom feature for increasing a resolution of the map and increasing a detail of the visual icon.

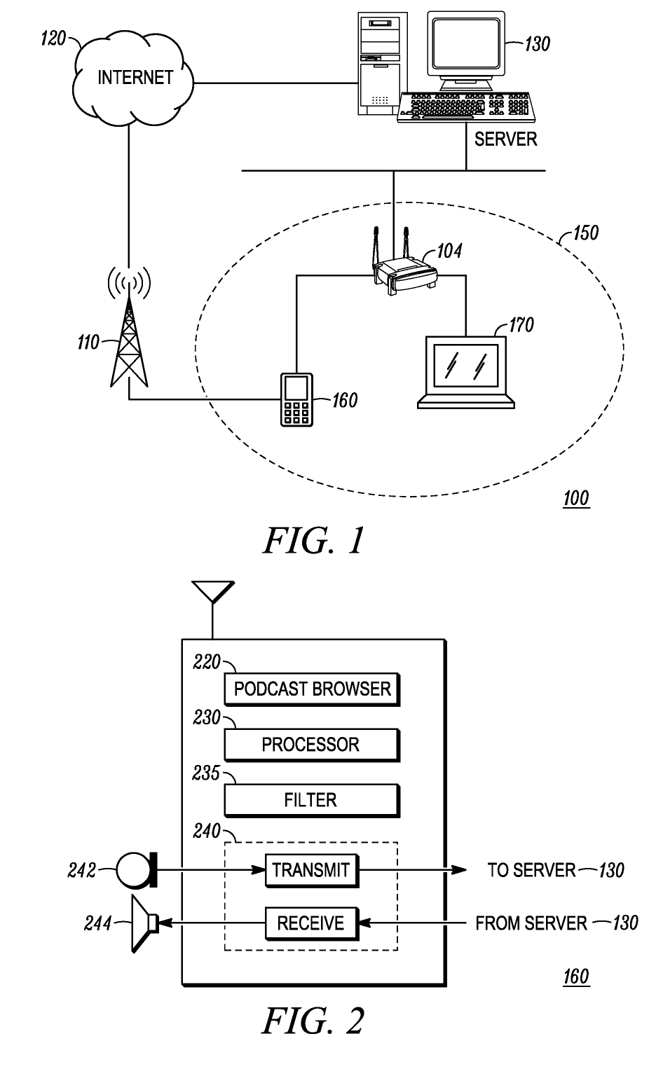

Referring to FIG. 1, a mobile communication environment 100 is shown. The mobile communication environment 100 can provide wireless connectivity over a radio frequency (RF) communication network or a Wireless Local Area Network (WLAN). Communication within the network 100 can be established using a wireless, copper wire, and/or fiber optic connection using any suitable protocol (e.g., TCP/IP, HTTP, etc.). In one arrangement, a mobile device 160 can communicate with a base receiver 110 using a standard communication protocol such as CDMA, GSM, or iDEN. The base receiver 110, in turn, can connect the mobile device 160 to the Internet 120 over a packet switched link. The internet 120 can support application services and service layers for providing media or content to the mobile device 160. The mobile device 160 can also connect to other communication devices through the Internet 120 using a wireless communication channel. The mobile device 160 can establish connections with a server 130 on the network and with other mobile devices 170 for exchanging data and information. The server can host application services directly, or over the internet 120

The mobile device 160 can also connect to the Internet 120 over a WLAN. Wireless Local Access Networks (WLANs) provide wireless access to the mobile communication environment 100 within a local geographical area. WLANs can also complement loading on a cellular system, so as to increase capacity. WLANs are typically composed of a cluster of Access Points (APs) 104 also known as base stations. The mobile communication device 160 can communicate with other WLAN stations such as the laptop 170 within the base station area 150. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 160 can send and receive data to the server 130 or other remote servers on the mobile communication environment 100.

The mobile device 160 can be a cell-phone, a personal digital assistant, a portable music player, an electronic map, a navigation system or any other suitable communication device. The mobile phone 160 and the laptop 170 can be equipped with a transmitter and receiver for communicating with the AP 140 according to the appropriate wireless communication standard. In one embodiment of the present invention, the wireless station 160 is equipped with an IEEE 802.11 compliant wireless medium access control (MAC) chipset for communicating with the AP 140. IEEE 802.11 specifies a wireless local area network (WLAN) standard developed by the Institute of Electrical and Electronic Engineering (IEEE) committee. The standard does not generally specify technology or implementation but provides specifications for the physical (PHY) layer and Media Access Control (MAC) layer. The standard allows for manufacturers of WLAN radio equipment to build interoperable network equipment.

The mobile device 160 can send and receive media to and from other devices within the mobile communication environment 100 over the WLAN connection or the RF connection. In one example, the mobile device 160 can connect to the server 130 for receiving one or more podcasts. The mobile device 160 can transmit and receive data packets containing audio, text, or video from the server 130 through a podcast website hosted on the server 130. The server 130 can stream media to the mobile devices 160 for podcasting. In one arrangement, the server 130 can feed media from one or more external sources to the mobile device. For example, a podcast may reference, or hyperlink, media from various sources. In another arrangement, the mobile device 160 can communicate with the laptop 170 over a peer-to-peer network for receiving and transmitting podcasts. The term “podcast” can mean both the content and the method of delivery.

Referring to FIG. 2, the mobile device 160 of FIG. 1 for presenting one or more podcasts is shown. The mobile device 160 can include a podcast browser 220 for searching and selecting one or more podcasts. The podcast browser 220 can display one or more visual icons corresponding to one or more podcasts. A user can identify one or more attributes of a podcast from a visual icon. The visual icons can be presented in an arrangement that allows for rapid podcast browsing. The mobile device 160 can also include a processor 230 for rendering a visual icon and coordinating a delivery of a selected podcast. The processor 230 can be a microprocessor or DSP that can perform signal processing functions for capturing or presenting a podcast and performing image processing functions for presenting visual icons in a three-dimensional display. The mobile device 160 can include a filter 235 for screening podcasts by certain criteria, such as podcast category, or popularity. Notably, the filter 235 can be employed as a function within the processor 230 but is shown separately. The filter 235 can identify one or more attributes within podcast information blocks and screen the visual icons based on the podcast attributes. The mobile device 160 can include a microphone 242 for composing or editing one or more podcasts. For example, a user can subscribe to an audio blog and add voice content to the blog. The mobile device 160 can also include a speaker 244 for playing audio of the one or more podcasts. The microphone 242 and the speaker 244 are not novel to the invention.

The mobile device 160 can also include a communications module 240 having a transmit module and receive module for receiving media and presenting the one or more podcasts to the processor 230. The communication module 240 can support packet data and establish a communication link to one or more media sources, such as the server 130, for providing a connection to a Universal Resource Indicator (URI), a hyper transfer text protocol (HTTP) address, or an Internet Protocol (IP) address. The server 130 can also push one or more podcasts requested to the mobile device 160. The communication module 240 can receive encoded podcast information and extract one or more attributes of a podcast from the encoded podcast information. For example, a podcaster (such as the server 130) can packetize attributes of a podcast which can be sent to the mobile device 160. Attributes of a podcast are sent rather than the entire podcast media for reducing the amount of data that is sent over the communication channel. The podcast browser 220 can create visual icons based on the one or more attributes extracted by the communication module without downloading the podcast media. The attributes provide selective podcast information which allows the user to screen podcasts prior to downloading a podcast. Upon the user selecting a visual icon corresponding to a podcast, the mobile device 160 can download the selected podcast.

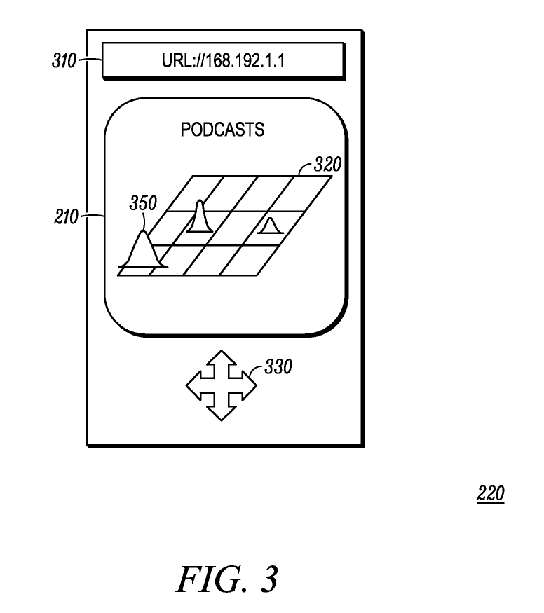

Referring to FIG. 3, the podcast browser 220 of FIG. 2, is shown in greater detail. The podcast browser 220 can include an address bar 310 for entering an address of a podcast, a display 210 for presenting one or more visual icons 350 in a three-dimensional grid 320, and a selector 330 for selecting the one or more visual icons 350 in the display 210. A user can enter in a URI of a podcast into the address bar 310 and, in response, a visual icon corresponding to attributes of one or more podcasts can be presented in the display 210. Aspects of the visual icon correspond to one or more attributes of a podcast. For example, the dimensions of the visual icon can correspond to podcast listening statistics such as the number of listeners or a popularity rating. Upon viewing the visual icons, a user can download a podcast by selecting a visual icon. A user can navigate and select one or more visual icons via interaction with the selector 330 for downloading a podcast.

The mobile device 160 can receive media from one or more podcasters through communication ports or interfaces. A podcaster may be a server 130 (See FIG. 1) that hosts media on one or more websites. The server 130 can “push” media to the mobile device 160 for presenting the podcast. In principle, the podcaster (e.g. information provider such as the server 130) chooses which files to offer in a feed to the mobile device 160. The server can establish broadcast times, such as daily news times, for podcasting the media. The user can then select which media to receive among available feed channels provided by the podcaster. For example, the user may elect to receive only a few episodes of a podcast from one or many episodes pushed by the server 130. The user can subscribe to certain episodes of a broadcast.

In one arrangement, the podcast browser 220 can automatically identify one or more podcasts, and present visual icons 350 corresponding to the one or more podcasts in the display 210. That is, the user does not need to enter in an address of the podcasts. The mobile device can scan a local region and present visual icons for one or more available podcasts. The display 210 can also present the podcast upon a selection of a visual icon 350. For example, the podcast may stream images or a video to the mobile device 160. The display 210 is not limited to presenting only visual icons, and can perform display operations similar to mobile device displays. For example, the display 210 can be an LCD display or any other suitable electronic display system capable of presenting images, video, or graphics. In one arrangement, the podcast browser 220 can also present a geographical map on the display. Visual icons 350 can be overlaid on the geographical map at positions corresponding to a geographic location of a podcast. A user can download a podcast from a location by selecting a visual icon 350 corresponding to the location.

The visual icons 350 can be presented in the three-dimensional grid 320 for facilitating podcast selection. In one arrangement, the podcast browser 220 can arrange the visual icons in a row-column format in the three-dimensional grid 320 based on a podcast category. For example, each column of a podcast can correspond to a subject matter of the podcast. Each row of a column can correspond to a podcaster within the subject matter. For instance, two or more podcasters may push podcasts having similar subjects which can be presented in the same column but at different rows. Each display cell can include a visual icon 350 that corresponds to a single podcaster. The podcast browser 220 can also sort the visual icons based on one or more user preferences. For example, the user may prefer to present the most popular podcasts of a subject at the front of the three-dimensional grid. The popularity may be a function of the number of users currently listening or the number of listeners expected to subscribe. The podcast browser 220 can sort the visual icons of a particular subject matter based on the attributes of the visual icon. For example, the visual icons can be sorted based on an size, area, or color of the visual icons. Notably, aspects of the visual icons correspond to one or more attributes of a podcast.

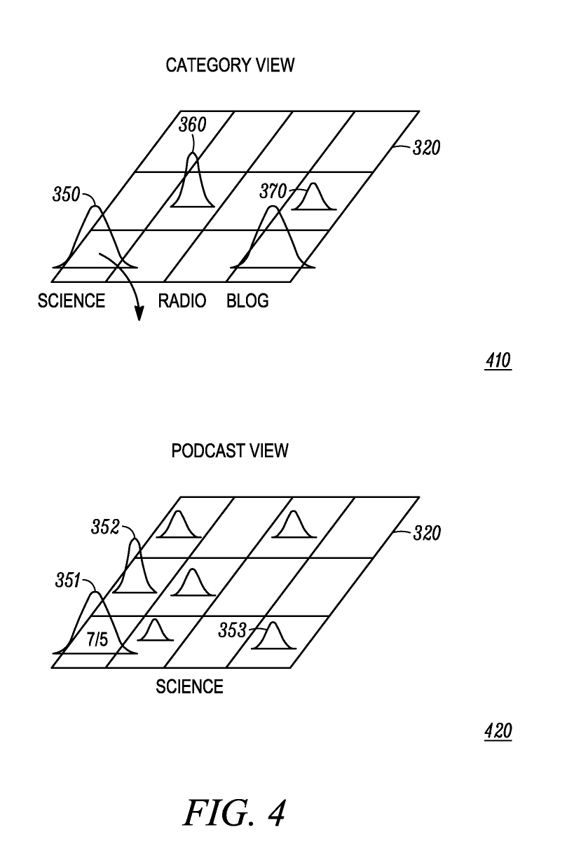

Referring to FIG. 4, two views of the three-dimensional grid in the display 210 of the podcast browser 220 are shown. The two views are multi-level in that one view can “expand” to the next view. The first view is a category view 410 which corresponds to a broad level view of one or more podcasters (350, 360, and 370) sorted by category. The second view is a podcast view 420 for one or more podcasts (351, 352, and 353) pushed by a particular podcaster (such as podcaster visual icon 350). The three-dimensional grid 320 can include more than the number of views shown, which are presented for mere illustration of the multi-level podcast browser for searching and selecting podcasts. In the category view 410, podcasters (350, 360, and 370) can be identified by a visual icon, and sorted based on a subject matter, or category, that the podcasters push. In the category view 410, a visual icon collectively represents the podcasts a podcaster pushes. For example, a podcaster may push one or more podcasts under a similar category. Attributes of the visual icon in the category view 410, such as the height or width of visual icon 350, may describe the number of podcasts pushed by the podcaster. In the podcast view 420, the visual icon represents attributes of a particular podcast. For example, the visual icons (351, 352, and 353) are podcasts pushed by podcaster visual icon 350. A visual icon 351 is one particular podcast that can express the podcast's attributes, such as a popularity of the podcast or a length of the podcast. Notably, a visual icon can assume different meaning in either the category view 410 or the podcast view 420.

The podcast browser 220 provides a multi-level scope for arranging podcasters based on a category in the category view 410. For example, the category view 410 can list podcasters by subject matter within the three-dimensional grid 320 and sort the podcasters by the subject matter. For instance, podcaster visual icon 350 can be science, podcaster visual icon 360 can be math, and podcaster visual icon 370 can be blog. In practice, the podcast browser 220 can assign a visual icon 350 to a display cell in the three-dimensional grid 320 based on a category of the podcaster. In particular, the visual icon 350 in the category view 410 represents a single podcaster. Upon a user selecting the visual icon 350 corresponding to the single podcaster, the podcast view 420 for the selected podcaster is displayed.

The podcast view 420 presents the podcasts pushed by the podcaster. For example, the podcaster visual icon 350 can expand to podcast visual icons 351-353 which each represent a podcast. Notably, the podcast view 420 is an expansion of a single podcaster visual icon 350. The category view 410 allows a user to evaluate attributes of one or more podcasters, and the podcast view 420 allows the user to identify one or more podcasts pushed by the podcaster. The podcasts 351-353 in the podcast view 420 can be arranged by various criteria. For example, the podcasts can be arranged or sorted in the three-dimensional grid 320 based on a date. As another example, the most recent podcasts can be presented near the front of the display in the three-dimensional grid 320. As yet another example, the podcasts can be sorted and arranged based on popularity. Understandably, the podcasts can be arranged in the three-dimensional grid 320 based on one or more aspects of the visual icons but are not limited to this arrangement. One can appreciate that the arrangement of icons may in fact not be based on—dimensional aspects of the visual icon. The sorting and arrangement can be specified by a personal profile created by the user. Understandably, the user can select the ordering of the visual icons in the three-dimensional grid 320 for facilitating a search and selection of podcasts based on personal criteria. An options window may be presented which allows the user to select the arrangement of icons on the display 210. The podcast browser 220 provides a multi-level scope for searching and selecting pod cast. That is, a user can scan for podcasters at a broad level category view 410, and upon selecting a podcaster, narrow the search down to one or more podcasts pushed by the selected podcaster.

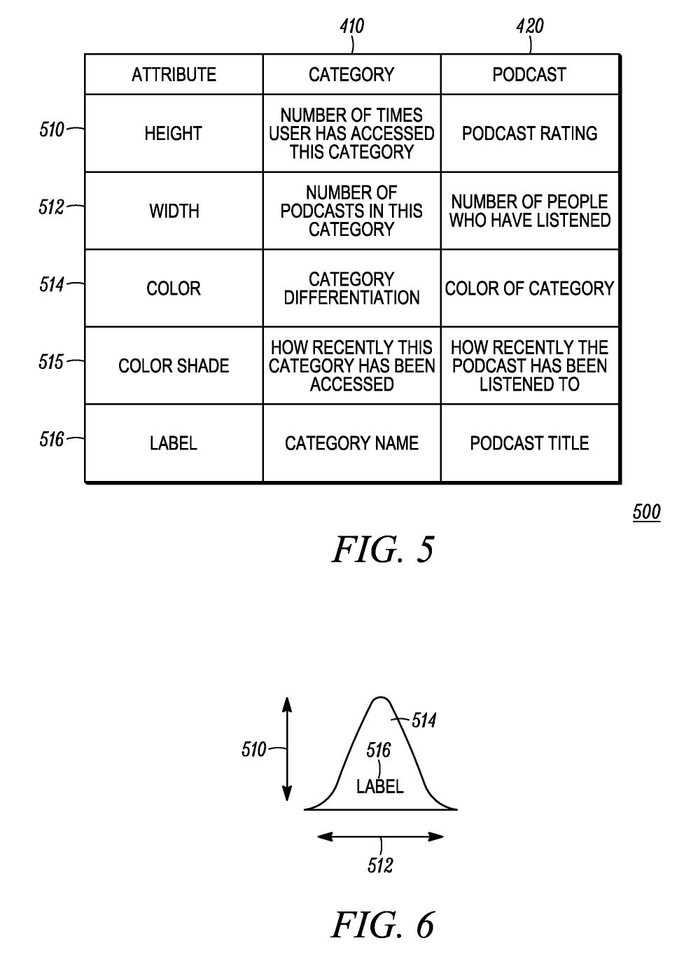

Upon selecting the visual icon 350, the user is presented with the podcast view 420. The podcast view 420 presents one or more podcasts available within the category. One or more attributes of a podcast can be specified as a height, a width, a color, a shade, or a label of a visual icon. A user can identify a podcast based on visualized aspects of the visual icons 351-353. That is, aspects of the visual icon 350 in the podcast view 420 can correspond to attributes of a podcast. For example, referring to FIG. 5, a table 500 for presenting associations between attributes of a podcast and aspects of a visual icon are shown. Notably, the table 500 identifies a first set of attributes for visual icons (350, 360, and 370) under a category view 410, and a second set of attributes for visual icons (351 to 353) under a podcast view 420. In the category view 410, aspects of the visual icon 350 correspond to attributes of a category 410. In the podcast view 420, aspects of the visual icon correspond to attributes of a podcast 420. Notably, aspects of the visual icon convey a different meaning based on the view.

In the category view 410, a height 510 of the visual icon 350 can correspond to a number of times a user has accessed a category. A width 512 of the visual icon 350 can correspond to a number of podcasts in the category. A color 514 of the visual icon can correspond to a category differentiation. For example, a visual icon can be red for a science category, or blue for a math category. A color shade 515 can describe how recently the category has been accessed in the category view 410. For example, a visual icon may be a dark shade of red for indicating recent podcast blogging activity in the science category. A label 516 can also be included with the visual icon for providing a text description of the category name. For example, the visual icon 350 in the category view 410 can have a label “NASA@science” for identifying the podcaster.

In the podcast view 420, a height 510 of the visual icon 351 can correspond to a podcast rating. For example, a listener within a podcast listening community may assign a rating to the podcast. Understandably, the listener can post a rating to provide an opinion to other listeners. For example, the rating may be based on the content of the podcast, the quality of service delivery for the podcast, or the relevance of the podcast to the category. A width 512 of the visual icon 350 can correspond to a number of people who have listened to the podcast. A color 514 of the visual icon can correspond to a sub-category of the podcast. For example, sub-categories within the field of science can have various colors. A color shade 515 can describe how recently the category has been listened to. A label 516 can also be appended to the visual icon for providing a text description of the podcast title. For example, the visual icon 351 in the category view 410 can have a label “Supernovas” for identifying a podcast pushed by the “NASA@science” podcaster.

The aspects of the visual icon presented in Table 500 are shown as dimensions or coloration attributes of the visual icon in FIG. 6. Notably, the visual icon of FIG. 6 presents one or more attributes of a podcast as one or more visual icon features. That is, an attribute of a podcast corresponds to a height, a width, a color, a color shade, or a label of the visual icon. With reference to Table 500 in FIG. 5, the height represents a number of times a user has accessed a category, the width represents a number of podcasts in the category, the color represents a differentiation of the category, the color shade represents a measure of how recent the category has been accessed, and the label represents a name of the category. Understandably, the shape of the visual icon can also convey an attribute of a podcast though not shown.

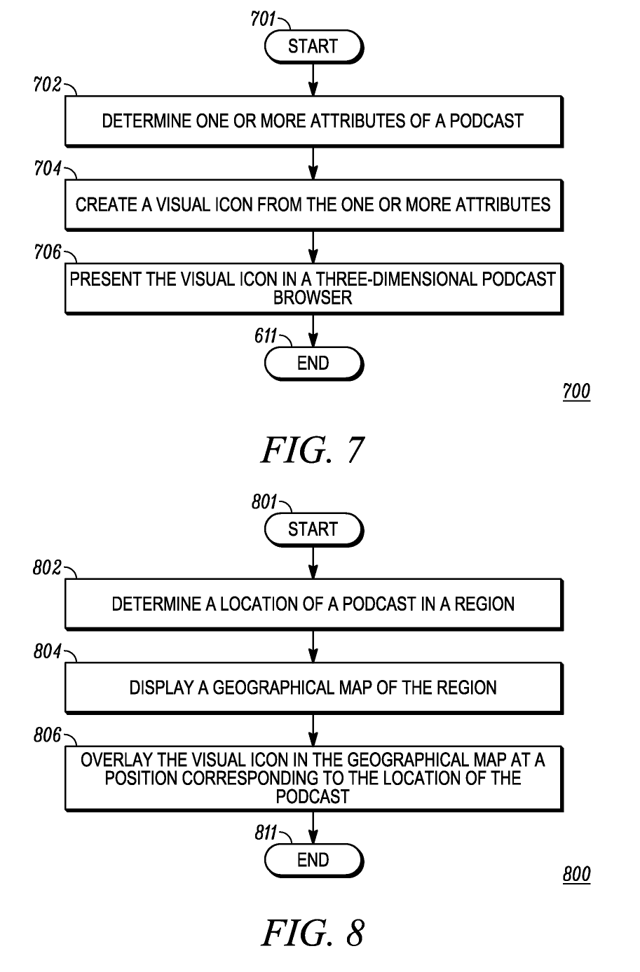

Referring to FIG. 7, a method 700 for podcast browsing is shown. The method 700 can be practiced with more or less than the number of steps shown. To describe the method 700, reference will be made to FIGS. 1, 2, 3 and 5 although it is understood that the method 700 can be implemented in any other suitable device or system using other suitable components. Moreover, the method 700 is not limited to the order in which the steps are listed in the method 700. In addition, the method 700 can contain a greater or a fewer number of steps than those shown in FIG. 7. The method 700 provides a means for podcast browsing.

At step 701, the method 700 can start. The method 700 can start in a state wherein a user of a mobile device has access to one or more podcasts. That is, the mobile device can receive one or more podcasts from one or more podcasterers which can be presented to the user. The mobile device can receive podcast information from the one or more podcasters without downloading the entire podcast. For example, briefly referring to FIG. 1, the podcasters (such as the server 130) can encode one or more attributes of a podcast in a podcast information block for providing compressed podcast information. The podcast information block can be included as metadata in an XML format. The mobile device 160 can receive the podcast information block upon the user activating the podcast browser 220 (See FIG. 3).

At step 702, one or more attributes of a podcast can be determined. Attributes of a podcast can include podcast listening statistics such as a number of listeners, a podcast popularity rating, a podcast running length, or a frequency of podcasts. Attributes of a podcast can also include attributes of a podcaster providing the podcast. Briefly referring to FIG. 2, the communications unit 240 can decode one or more attributes in the metadata of a podcast information block. The podcast browser 220 utilizes the attribute information to render the visual icons. For example, prior to decoding, the podcaster (such as the server 130) encodes one or more attributes of a podcaster or podcast in the podcast information block. The attributes can include a name of a podcaster, a title of a podcast, a rating of the podcast, a length of the podcast, a category and the like. The category can be a subject such as news, music, talk radio, education, technology, sports, travel, blogs, politics, chat, and culture, but is not herein limited to these. The communications module 240 can receive the attributes, such as the category information, from the server 130 and the podcast browser 220 can render the visual icons in the three-dimensional grid 320 according to category and other attributes extracted from the podcast information block.

Referring back to FIG. 5, the table 500 provides attributes for the podcast category view 410 and the podcasts within a podcast view 420. It should be noted that a podcaster (such as the server 130 in FIG. 1) or the mobile device 160 generates the attribute information. For example, the podcaster can determine the number of times a user has accessed a category, a number of podcasts in a category, a category differentiation, how recently a category has been accessed, and a category name. The podcaster (130) can also assign a podcast rating based on listener reviews and determine a number of active or previous listeners of a podcast. The podcaster (130) can identify how recently a podcast has been referenced and the titles of podcasts. For instance, a podcaster (130) can count the number of times a podcast link has been dereferenced for determining an activity of the podcast. Understandably, the podcaster (130) can determine one or more attributes of a category or a podcast, and assess one or more listener behaviors for assigning values to the attributes. These attributes can be included in the podcast listening block which can be decoded by the communications module 240. Alternatively, this information can be provided to the mobile device 160 which can determine the listener statistics or numerical information.

At step 704, a visual icon can be created from the one or more attributes. For example, referring to FIG. 3, the podcast browser 220, upon receiving attributes from the communication module 240, can commission the processor 230 to render a visual icon based on the one or more attributes. The one or more attributes can be specified as numerical values for rendering the visual icon. For example, briefly referring to FIG. 5, the attributes of the category view 410 and the podcast view 420 can correspond to aspects of the visual icon. For example, a podcast rating between 1 and 10 can be assigned to a visual icon height 510. A number of people who have listened to a podcast can be assigned to a visual icon width 512. The height can be scaled based on a display resolution. Other aspects of visual icon can be created in accordance with the one or more attributes listed in Table 500.

At step 706, the visual icon can be presented in the display of the podcast browser. Notably, the aspects of the visual icon correspond to attributes of the podcaster category or podcast as discussed in Table 500 (See FIG. 5). This allows the user to identify one or more attributes of a podcaster or podcast based on aspects of the visual icons. Briefly referring to FIG. 2, the processor 230 can place the visual icons in the three-dimensional display 320 in accordance with the view; that is, the category view or the podcast view. The processor can assign the attributes, such as listening statistics, to one or more aspects of the visual icon which can be a height, a width, a color, a color shade, and a label of the visual icon. Listening statistics can include a number of listeners, a podcast popularity rating, a podcast running length, or a frequency of podcasts. The processor can arrange the visual icons in the three-dimensional grid 320 in a row-column format based on a subject category but is not limited to this visual arrangement. At step 711, the method 700 can end.

It should be noted that the podcast browser 220 can update aspects of the visual icons based on one or more user behaviors. For example, the podcast browser 220 evaluates a user behavior and updates the one or more visual icons based on the user behavior, wherein the user behavior is a number of times the user has accessed a category, a number of podcasts in the category, a differentiation of the category, a measure of how recent the category has been accessed, and a name of the category. In another arrangement, the podcast browser 220 evaluates a podcast listening community behavior, and updates the one or more visual icons based on the podcast listening community behavior, wherein the podcast listening community behavior is a number of times the podcast listening community has accessed a category, a number of podcasts in the category, a differentiation of the category, a measure of how recent the category has been accessed, and a name of the category. Notably, the podcast browser 220 informs the processor 230 to adjust one or more aspects of the visual icon, such as a color, height, or width in accordance with changes to the one or more user behaviors.

Referring to FIG. 8, a method 800 for presenting one or more podcasts based on a geographical region is shown. Reference will be made to FIGS. 1, 2, 3 and 9 when describing the method 800. The method 800 is not limited to the order in which the steps are listed in the method 800. In addition, the method 800 can contain a greater or a fewer number of steps than those shown in FIG. 8. At step 801, the method can begin. At step 802, a location of a podcast in a region can be determined. The location can be specified as a geographical coordinate such as longitude and latitude commonly used in Global Positioning Systems (GPS) information, or Cartesian Coordinate information but is not limited to either. Notably, a podcaster pushing a podcast can be associated with a particular location, for example, a street address where a server providing the content of the podcast resides. The server can include the positional information within a podcast information block that can be sent to a podcast client, such as a mobile device. Referring back to FIG. 2, the communications module 240 of the mobile device 160 can decode positional information from the podcast information block received in a data packet from the server 130. The positional information can be GPS data present in metadata of the data packet.

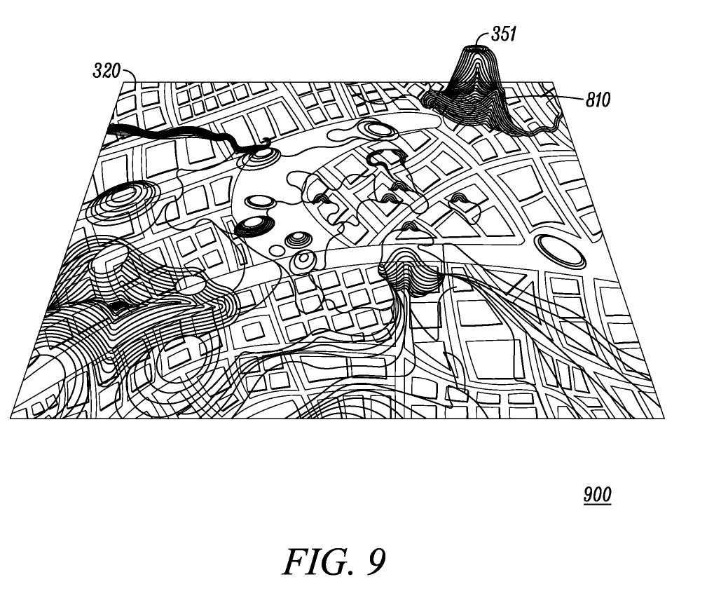

At step 804, a geographical map of the region can be displayed. The geographical map can correspond to a region associated with the positional information provided by a server, or a location entered by the user. For example, a general region corresponding to the street address listed in the podcast information block can be displayed. Alternatively, the user can enter a location in the address bar 310 (See FIG. 3). Understandably, the processor 230 determines a location of a podcast based on the positional information received at step 802. The podcast browser 220 then presents a geographical map in the display that corresponds to a region of the podcast location. At step 806, the visual icon can be overlaid in the geographical map at a position corresponding to the location of the podcast. For example, referring to FIG. 3, the podcast browser 220 presents a visual icon of the podcast on the display at the location determined by the processor 230. Referring to FIG. 9, a podcast map 900 corresponding to an overlay of a visual icon on a geographic map is shown. The podcast map 900 can be a topographical map of presented in a three-dimensional format for improving a visualization of podcasts within the region. The position of the visual icon 351 on the podcast map 900 corresponds to a location of a podcast in the region. Aspects of the visual icon 351 in the podcast map 900 can correspond to one or more attributes of the podcast as discussed in Table 500.

In one arrangement, subject filters can be overlaid on the podcast map 900 for showing only visual icons containing subject matter specified by the subject filter. For example, referring back to FIG. 1, a user can adjust the filter 235 for selecting podcasts based on a category, such as subject matter, or an attribute. For instance, the user can enter textual information describing podcast categories the user is interested in receiving. The filter 235 can screen out visual icons that do not meet the filter specifications entered by the user. In effect, visual icons in the podcast map are selectively filtered based on user requests. For example, visual icons not corresponding to the subject filter can be visually removed or altered. For instance, a transparency of visual icons can be adjusted in accordance with the filter specifications. The filter 235 can make visual icons translucent if they do not satisfy a subject matter criterion. Understandably, podcasts can be selected for display by the filter 235, thereby reducing the amount of podcast information presented on the display.

Notably, the podcast browser 220 also provides multi-level zooming into the geographical map 900 for increasing a resolution of the region and increasing a detail of the visual icon. For example, the user can zoom into the map using the selector 330. The user can identify one or more attributes of a podcast in the region based on aspects of the visual icon. In a default configuration, the podcast browser can present a region corresponding to a location of the mobile device 160. In this arrangement, a user can visualize podcasts in their local area. In another arrangement, the user can specify a remote region by entering a city, state, address, zip code, or country code into the address bar 310 of the podcast browser 220. The user can visualize podcasts in the remote region and evaluate one or more attributes of a podcast through the multi-level viewing capabilities of the podcast browser. A user can navigate to a podcast in the geographical map through interaction with the selector 330. At step 811, the method can end.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A electronic device for visualizing podcast attributes, comprising
a display for presenting one or more visual icons in a three-dimensional grid, wherein a visual icon identifies one or more attributes of a podcast.

2. The electronic device of claim 1, further comprising:
a podcast browser for searching and selecting one or more visual icons presented in the display,
wherein the podcast browser provides multi-level viewing for the one or more visual icons.

3. The electronic device of claim 1, wherein an attribute of a podcast corresponds to a height, a width, a color, a color shade, or a label of a visual icon.

4. The electronic device of claim 3, wherein the height represents a number of times a user has accessed a category, the width represents a number of podcasts in the category, the color represents a differentiation of the category, the color shade represents a measure of how recent the category has been accessed, and the label represents a name of the category.

5. The electronic device of claim 1, wherein the podcast browser evaluates a user behavior or a podcast listening community behavior and assigns the user behavior to one or more attributes of a visual icon,
wherein the behavior is a number of times a user has accessed a category, a number of podcasts in the category, a differentiation of the category, a measure of how recent the category has been accessed, and a name of the category.

6. The electronic device of claim 1, further comprising:
a communication module for receiving encoded podcast information and extracting one or more attributes of a podcast from the encoded podcast information,
wherein the podcast browser renders the visual icons based on the one or more attributes extracted by the communication module.

7. The electronic device of claim 1, wherein the podcast browser assigns a visual icon to a display cell in the three-dimensional grid based on a category of the podcast,
wherein a category is a subject including news, music, talk radio, education, technology, sports, travel, blogs, politics, or culture.

8. The electronic device of claim 1, wherein the podcast browser presents a geographical map, and displays the visual icon at a position in the geographical map corresponding to a geographic location of the podcast, wherein the geographic location corresponds to a location of where the podcast was created.

9. An electronic device for presenting one or more podcasts, comprising:
a display for presenting a geographical map of a region;
a processor for determining a location of a podcast in the region;
a podcast browser for presenting a visual icon of the podcast at a position in the geographical map corresponding to the location determined by the processor,
wherein the visual icon identifies one or more attributes of the podcast.

10. The electronic device of claim 9, wherein an attribute of the podcast is specified as a height, a width, a color, a shade, or a label of the visual icon.

11. The electronic device of claim 9, wherein the podcast browser provides multi-level zooming for increasing a resolution of the region and increasing a detail of the visual icon.

12. The electronic device of claim 9, wherein the display controls a scope of the region that is specified by city, state, address, zip code, or country code.

13. The electronic device of claim 8, further comprising a subject filter for screening podcasts by a category.

14. The electronic device of claim 8, wherein the electronic device is a cell-phone, a portable music player, a personal digital assistant, an electronic map, or a navigation system.

15. A method for podcast searching and selecting, comprising:
determining one or more attributes of a podcast;
creating a visual icon from the one or more attributes; and
presenting the visual icon in a three-dimensional podcast browser, wherein one or more visual icons are presented in the three-dimensional podcast browser for identifying one or more podcasts, and an attribute of a podcast is specified as a height, a width, a color, a shade, or a label of the visual icon.

16. The method of claim 15, further comprising arranging the visual icons in the three-dimensional browser in a row-column format based on a subject category.

17. The method of claim 15, further comprising subscribing to a podcast upon a selection of a visual icon.

18. The method of claim 15, further comprising:
encoding the one or more attributes for providing compressed podcast information; and
including the information as metadata in an XML format.

19. The method of claim 15, further comprising determining podcast listening statistics that include a number of listeners, a podcast popularity rating, a podcast running length, or a frequency of podcasts, and assigning the listening statistics to one or more aspects of the visual icon, wherein the aspects are one of a height, a width, a color, a color shade, or a label of the visual icon.

20. The method of claim 15, further comprising:
determining a location of the podcast in a region;
displaying a geographical map of the region; and
overlaying the visual icon in the geographical map at a position corresponding to the location of the podcast.
